(19) United States
(12) Patent Application Publication
(10) Pub. No.: US 2025/0086993 A1
(43) Pub. Date: Mar. 13, 2025

(54) Artificial Intelligence Techniques for Generating a Predicted Future Image of Microorganism Growth

(71) Applicants: NEOGEN FOOD SAFETY US HOLDCO CORPORATION, LANSING, MI (US); 3M INNOVATIVE PROPERTIES COMPANY, Saint Paul, MN (US)

(72) Inventors: Muhammad Jamal Afridi, Lansing, MI (US); Vahid Mirjalili, Lansing, MI (US); Sailaja Chandrapati, Lansing, MI (US); Subhalakshmi Meena Falknor, Lansing, MI (US); Kuangxiao Gu, Lansing, MI (US); Gautam Singh, Lansing, MI (US); Haley Saddoris, Lansing, MI (US); Hugh Eugene Watson, Lansing, MI (US); Neil Percy, Lansing, MI (US); Robert Koch, Lansing, MI (US)

(21) Appl. No.: 18/727,473

(22) PCT Filed: Jan. 10, 2023
(86) PCT No.: PCT/IB2023/050224

§ 371 Date: Jul. 9, 2024

Related U.S. Application Data
(60) Provisional application No. 63/267,400, filed on Feb. 1, 2022.
(60) Provisional application No. 63/266,589, filed on Jan. 10, 2022.

(51) Int. Cl. G06V 20/69; G06V 10/70

(52) U.S. Cl. CPC G06V 20/693; G06V 10/70

(57) ABSTRACT

An example system includes an image capture device configured to capture a sequence of images representative of a sample of microbial growth; and a processing unit having one or more processors, the one or more processors configured to pass the image data for the sequence of images through a machine learning model trained to generate one or more predicted future images of the microbial colony at a future time, the machine learning model trained using historical image data, the historical image data comprising a plurality of historical image data sets, each historical image data set of the historical image data sets comprising image data for a historical sequence of images of a corresponding historical microbial colony sample, wherein a prediction time interval between the future time and a capture time of a last image of the sequence of images is greater than each of the sampling time intervals.

### BACKGROUND

Many real-world processes, especially those of chemical and biological nature, evolve overtime. For example, microbial growth may initially be undetectable, but may become detectable after an incubation period that provides sufficient time for microbes to replicate and form colonies that are visible, for example, to a human eye or to a camera or other recording device. In order to test for the presence or number of microorganisms on or in a substance, a sample of a substance may be taken and placed under conditions, usually elevated temperature in the presence of nutrients, for a period of time sufficient to permit any microorganisms (e.g., bacteria, yeast, fungi, molds, etc.) that may be present to replicate and form colonies that can be detected and/or counted. For example, to test for the presence of microorganisms in food or on food processing equipment, samples may be taken of the food or from a surface of the food processing equipment and placed on a culture plate (e.g., a Petri dish or other substrates, such as certain films, that can be used to culture cells). After an incubation time, which can be as long as 24 hours, 72 hours, or in some cases even longer, the number of colony forming units (CFUs) of microbes on the sample plate can be counted, thus providing information regarding the presence and/or number of microorganisms in the sample.

### SUMMARY

In general, this disclosure describes techniques for generating predicted future images indicating the growth of a current sample of microorganisms (bacteria, yeast, mold, etc.). More specifically, this disclosure describes example techniques for generating a predicted future image based on applying machine learning models to a time series of images of a sample plate. The predicted future image can be provided hours or days in advance of an actual image of microbial growth, thereby enabling a decision maker to make an early determination of the presence and quantity of microorganisms, based on a reasonably accurate prediction of the probable future image of the expected microbial growth.

As described herein, an image capture device or component of a prediction device can capture a time series of images of microbial growth at a relatively early state of microbial growth, for example, during the first eight hours, sixteen hours, or twenty-four hours of growth. The prediction device can generate a predicted future image of the microbial growth as it would appear at a future point in time, for example twenty four, forty-eight, or seventy-two hours in the future correspondingly. A processing unit of the prediction device receives the image data, and provides the image data to a machine learning model that has been trained to generate the predicted future image of the microbial growth. For example, microbial growth may ordinarily require a twenty-four to forty-eight hour growth period of growth before the microbial colony is large enough to be relied upon for decision making purposes. In the various examples set forth herein, the prediction device can receive a time series of images from an initial period of growth, for example, an initial eight hour period, and process the time series of images to generate a predicted future image of the microbial growth as it would likely appear after twenty-four, forty-eight, or seventy two hours of growth.

The techniques of this disclosure may provide at least one technical advantage over existing methods. For example, a practical application of the techniques disclosed herein is a prediction device that can generate a predicted future image of microbial growth that can be used to make decisions regarding the presence and quantity of microbial numbers, well before the microbial growth can be visualized and enumerated. Using the example above, the prediction device using the technique disclosed herein can reduce a waiting period for a decision based on a sample of microbial growth from twenty-four to forty-eight hours down to eight hours or twenty-four hours correspondingly. The ability to make an earlier determination can provide the end user with results based on presence and enumerated quantities of microbial growth in a shorter time period than technique requiring longer incubation times.

In one example, this disclosure describes a system that includes an image capture device configured to capture image data for a sequence of images representative of growth of a microbial colony at a plurality of times, each of the images prior to a final image of the sequence of images separated by a sampling time interval between the image and a next image; and a processing unit having one or more processors, the one or more processors configured to execute instructions that cause the processing unit to: pass the image data for the sequence of images through a machine learning model trained to generate image data representing one or more predicted future images of the growth of the microbial colony, each of the one or more predicted future images representative of the microbial colony at a corresponding future time, the machine learning model trained using historical image data, the historical image data comprising one or more historical image data sets, each historical image data set of the one or more historical image data sets comprising image data for a historical sequence of images of a corresponding historical microbial colony sample, wherein a prediction time interval between the future time and a capture time of a last image of the sequence of images is greater than each of the sampling time intervals, and output the image data representing the one or more predicted future images of the microbial colony.

In another example, this disclosure describes a method that includes receiving, by a processing unit comprising one or more processors, image data for a sequence of images representative of growth of a sample of a microbial colony, the images captured at a plurality of times, each image of the images prior to a final image of the sequence of images separated by a sampling time interval between the image and a next image; passing the image data for the sequence of images through a machine learning model trained to generate image data representing a one or more predicted future images of the microbial colony, each of the one or more predicted future images representative of the microbial colony at a corresponding future time, the machine learning model trained using historical image data, the historical image data comprising a plurality of historical image data sets, each historical image data set of the historical image data sets comprising image data for a historical sequence of images of a corresponding historical microbial colony sample, wherein a prediction time interval between the future time and a capture time of a last image of the sequence of images is greater than each of the sampling time intervals; and outputting the image data representing the predicted future image of the microbial colony.

In a further example, this disclosure describes a method that includes receiving historical image data, the historical image data comprising a plurality of historical image data sets, each historical image data set of the historical image data sets comprising image data for a historical sequence of images of a corresponding microbial colony sample, each image of the historical sequence of images prior to a final image of the historical sequence of images separated by a sampling time interval between the image and a next image; for each historical image data set of the plurality of historical image data sets, training the machine learning model to generate one or more predicted future images of the microbial colony, each image corresponding to a future time from the historical sequence of images, wherein a prediction time interval between the future time and a capture time of a last image of the historical sequence of images is greater than each of the sampling time intervals; and adjusting weights in layers of the machine learning model based on differences between the one or more predicted future images and one or more target images associated with the microbial colony samples.

In another example, this disclosure describes a system that includes means for receiving image data for a sequence of images representative of growth of a sample of a microbial colony, the images captured at a plurality of times, each image of the images prior to a final image of the sequence of images separated by a sampling time interval between the image and a next image; means for passing the image data for the sequence of images through a machine learning model trained to generate image data representing a one or more predicted future images of the microbial colony, each of the one or more predicted future images representative of the microbial colony at a corresponding future time, the machine learning model trained using historical image data, the historical image data comprising a plurality of historical image data sets, each historical image data set of the historical image data sets comprising image data for a historical sequence of images of a corresponding historical microbial colony sample, wherein a prediction time interval between the future time and a capture time of a last image of the sequence of images is greater than each of the sampling time intervals; and means for outputting the image data representing the predicted future image of the microbial colony.

In a further example, a this disclosure describes a method that includes means for receiving historical image data, the historical image data comprising a plurality of historical image data sets, each historical image data set of the historical image data sets comprising image data for a historical sequence of images of a corresponding microbial colony sample, each image of the historical sequence of images prior to a final image of the historical sequence of images separated by a sampling time interval between the image and a next image; for each historical image data set of the plurality of historical image data sets, means for training the machine learning model to generate one or more predicted future images of the microbial colony, each image corresponding to a future time from the historical sequence of images, wherein a prediction time interval between the future time and a capture time of a last image of the historical sequence of images is greater than each of the sampling time intervals; and means for adjusting weights in layers of the machine learning model based on differences between the one or more predicted future images and one or more target images associated with the microbial colony samples.

The details of at least one example of the disclosure are set forth in the accompanying drawings and the description below. Other features, objects, and advantages of the disclosure will be apparent from the description and drawings, and from the claims.

### BRIEF DESCRIPTION OF DRAWINGS

FIGS. 1A and 1B are block diagrams illustrating a system for generating a predicted future image of microbial growth, in accordance with at least one example technique described in this disclosure.

FIGS. 2A and 2B are block diagrams illustrating a training system, in accordance with at least one example technique described in this disclosure.

FIG. 3 is a block diagram illustrating another training system, in accordance with at least one example technique described in this disclosure.

FIGS. 4A-4C are block diagrams illustrating example training frameworks for the training systems illustrated in FIGS. 2 and 3, in accordance with at least one example technique described in this disclosure.

FIG. 5 is a block diagram showing a system for generating a predicted future image of microbial growth using tiled image data, in accordance with at least one example technique described in this disclosure.

FIG. 6 is a block diagram of an example processing unit of a system for generating a predicted future image of microbial growth, in accordance with at least one example technique described in this disclosure.

FIG. 7 is a flow diagram illustrating an example operation of a prediction system, in accordance with one or more techniques of this disclosure.

FIG. 8 is a flow diagram illustrating an example operation of a training system, in accordance with one or more techniques of this disclosure.

FIG. 9 illustrates an example sequence of images showing growth of a microbial colony over a period of time.

FIG. 10 shows example input image sequences and predicted future images generated in accordance with at least on example technique described in this disclosure.

### DETAILED DESCRIPTION

Systems and techniques are described for generating a predicted future image of microbial growth in a sample taken, for example, from a food product or food processing environment. An image capture device or component of a prediction system can capture a time series of the sample over an initial sample period, and generate a predicted future image of the sample as it would appear at a future point in time. The difference between the future point in time and the last sample of the time series may be referred to as a prediction interval. The sample period can be comparatively much shorter than the full growth period of a microbial colony that may be present in the sample, i.e., the sampling period may be much shorter than the prediction interval.

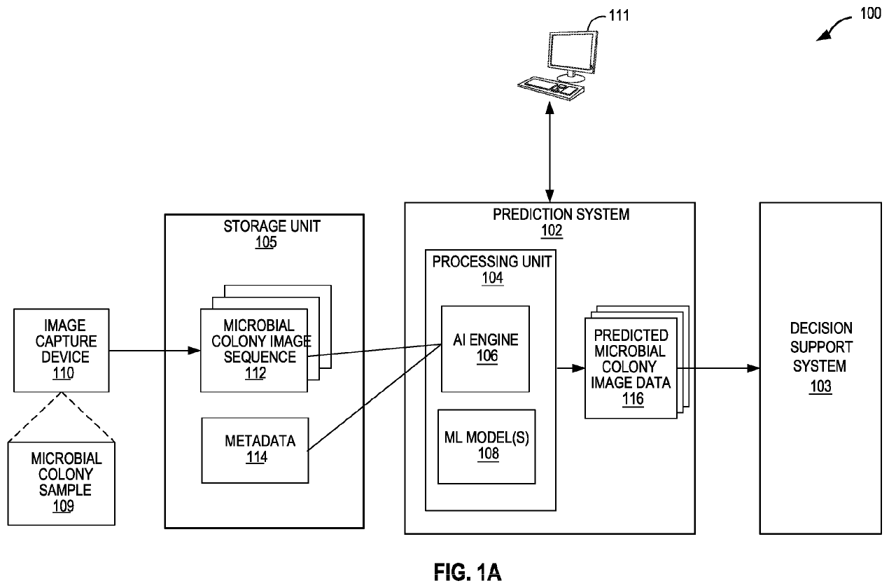

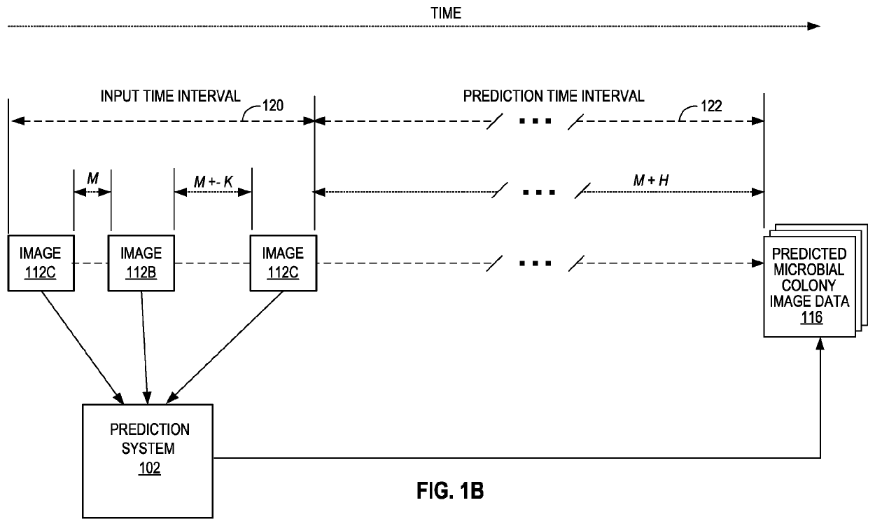

FIG. 1A is a block diagram illustrating a system for generating a predicted future image of microbial growth, in accordance with at least one example technique described in this disclosure. In some aspects, system 100 includes prediction system 102, image capture device 110, and user interface 111.

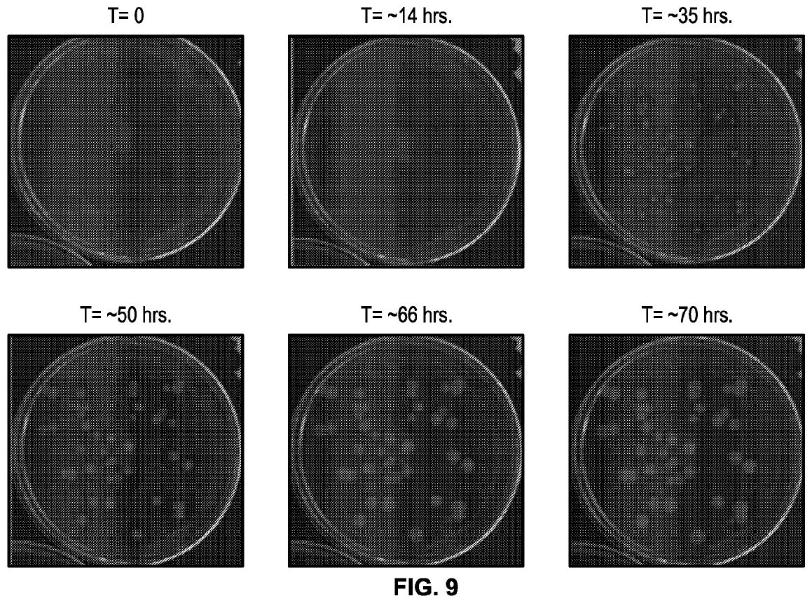

In some aspects, microbial colony sample 109 may be from a sample obtained from a food product, for example, a food product of a food product manufacturer. The food producer or intermediate carrier may wish to determine the microbial quality of its food product by taking samples of the food product and determining if there are microorganisms in the sample. The samples may be placed on a plate (e.g., a thin film culture plate) having a growth medium, and image capture device 110 may obtain a sequence of images of the plate. If a microbial colony is present in the sample, it will typically grow and become more visible as the sequence of images progresses. FIG. 9 shows an example microbial colony image sequence, with an initial image followed by image captures at approximately fourteen, thirty-five, fifty, sixty-six, and seventy hour marks during the sampling period. In some example implementations, microbial colony sample 109 may be placed on a thin film culture plate, such as those available under the PETRIFILM™ trademark from 3M Company, St Paul, Minnesota, USA, and image capture device 110 may be a plate reader, such as the PETRIFILM™ Plate Reader Advanced, available from 3M Company, St. Paul, Minnesota, U.S.A. However, the techniques disclosed herein may be applied as well to image data obtained from other thin film culture plate imaging systems.

Image capture device 110 obtains images of microbial colony sample 109. Image capture device 110 may be a camera or other components configured to capture image data representative of microbial colony sample 109. Image capture device 110 may include components capable of capturing image data, such as a video recorder, an infrared camera, a CCD (Charge Coupled Device) array, or a laser scanner.

Although one image capture device 110 is shown in FIG. 1A, there may be multiple image capture devices 110.

In some aspects, image capture device 110 captures a sequence (e.g., a time series) of images of microbial colony sample 109. The sequence of images is referred to herein as microbial colony image sequence 112. Each of the images in image sequence 112 are captured (or sampled) at different points in time. Image data for images within microbial colony image sequence 112 may be captured at different, and perhaps non-uniform, time intervals between image captures. Using the image sequence shown in FIG. 9 as an example, the time intervals between image captures in the sequence are approximately fourteen hours, twenty-one hours, fifteen hours, sixteen hours, and four hours.

In some aspects, an image in a sequence of images may be represented as a two-dimensional image. In some aspects, an image in a sequence of images can be a three-dimensional (3D) volume of images. For example, an image may be represented as a 3D volume of image data recorded over a relatively small period of time. As an example, the 3D volume may be a video recording. The three dimensions of the volume can be an x dimension, a y dimension, and a time dimension. Thus, capturing image data can refer to capturing a 2D image or recording multiple frames of image data as a 3D volume over a time period. In some aspects, the time period may correspond to the speed of colony growth. For example, the time period for a 3D volume for a first microbial colony may be thirty seconds, while the time period for a 3D volume for a second, slower growing, microbial colony may be five minutes.

After image capture device 110 captures an image of microbial colony sample 109, image capture device 110 may store the image data for the captured image to storage unit 105 as part of microbial colony image sequence 112. Image capture device 110 may associate a timestamp indicating when image capture device 110 captured the image. The timestamp may be stored with the image, or it may be stored as metadata 114. Metadata 114 may also include data such as environmental conditions when the sample was taken (e.g., temperature), environmental conditions of the sample plate, growth media of the sample plate etc.

Processing unit 104 of prediction system 102 can read microbial colony image sequence 112. For example, prediction system 102 may read microbial colony image sequence 112 in response to receiving a command from a user via user interface 111. Processing unit 104 can utilize artificial intelligence (AI) engine 106 and machine learning model 108 to process the image data of microbial colony image sequence 112, and optionally, metadata 114, to generate predicted microbial colony image data 116. In some aspects, AI engine 106 and machine learning model 108 may implement a neural network. For example, machine learning model 108 can define layers of a neural network that has been trained using techniques described herein to receive microbial colony image sequence 112 as input and to generate predicted microbial colony image data 116 as output. In some aspects, predicted microbial colony image data 116 is in the same form as image data for images in microbial colony image sequence 112. For example, if the images in microbial colony image sequence 112 are 2D images, then predicted microbial colony image data 116 represents a 2D image. Similarly, if the images in microbial colony image sequence 112 are 3D volumes, then predicted microbial colony image data 116 represents a 3D volume. In some aspects, predicted microbial colony image data 116 can have a different form from the image data for images in microbial colony image sequence 112. For example, the images in microbial colony image sequence 112 can be 3D volumes. Prediction system 102 can generate predicted microbial colony image data 116 as a 2D image.

In some aspects, prediction system may extract image processing features (e.g., difference from the initial image over time, gradient based images etc.) and use such features as an additional input to prediction system 102 and machine learning model 108.

As shown in FIG. 1A, predicted microbial colony image data 116 can be a sequence of images (e.g., 2D images or 3D volumes). In some aspects, the sequence of images may be a time sequence of predicted images having a temporal order. For example, the first image of predicted microbial colony image data 116 may be an earliest predicted image, and the last image may be a predicted image at a furthest point in time of the sequence.

In the example shown in FIGS. 1A and 1n the discussion above, microbial colony image sequence 112 is presumed to be a sequence of multiple images. In some aspects, microbial colony image sequence 112 may be a single image (e.g., a single 2D image or single 3D volume), and machine learning model 108 may be trained to generate predicted microbial colony image data 116 from a single input image.

In some aspects, prediction system 102 can provide predicted microbial colony image data 116 to decision support system 103. Decision support system 103 can analyze predicted microbial colony image data 116 to determine if food product that was the source of microbial colony sample 109 is of sufficient quality to be shipped to customers.

In some examples, user interface 111 allows a user to control system 100. User interface 111 can include any combination of a display screen, a touchscreen, buttons, speaker inputs, or speaker outputs. In some examples, user interface 111 is configured to power on or power off any combination of the elements of system 100, provide configuration information for prediction system 102, processing unit 104, and/or decision support system 103, and display output from prediction system 102.

FIG. 1B is a block diagram illustrating input image data for a system for generating a predicted future image of microbial growth, in accordance with at least one example technique described in this disclosure. In the example illustrated in FIG. 1B, image capture device 110 has captured image data for images 112A-112C at various points in time over input time interval 120. In this example, the time interval between the image captures of image 112A and image 112B is m hours. The time interval between the image captures of image 112B and image 112C is m±k hours. The prediction time interval 122 between image 112C and predicted microbial colony image data 116 is m+h hours. The prediction time interval 122 does not represent an amount of actual time passing. Instead, the prediction time interval m+h represents a simulated time interval between image 112C and predicted microbial colony image data 116. The actual time interval between image 112C and the generation of predicted microbial colony image data 116 can be merely the amount of time it takes prediction system 102 to generate predicted microbial colony image data 116. Prediction time interval 122 can be much longer than input time interval 120. For example, prediction time interval 122 can be longer than twice input time interval 120, and in some examples, can be even much longer.

As an example, image capture device 110 may create microbial colony image sequence 112 by capturing image data of microbial colony sample 109 every fifteen to thirty minutes over a six-hour period. Prediction system 102 can process microbial colony image sequence 112 to generate predicted microbial colony image data 116, representing a predicted future image of the microbial colony sample at a future point in time, for example, twenty-four hours in the future. The predicted future image can be used to determine whether the food product that was the source of the sample is safe for customer shipment or not. Using the techniques described herein, a user (or a user system) can use the predicted future image to reach a conclusion regarding food safety much earlier than would be possible using currently existing methods. In the example described above, the user can reach a conclusion regarding food safety twenty-four hours earlier than current methods.

The example shown in FIG. 1B illustrates several aspects of microbial colony image sequence 112 and predicted microbial colony image data 116. A first aspect is that there may be long sampling intervals. Each input image may be hours and days apart from each other. Within these intervals, there can be many changes governed by potentially non-linear processes. Thus, it is challenging to produce an accurate future image or 3D volume.

A second aspect is that the time intervals between image captures can be inconsistent and non-uniform. As shown in FIG. 1B, the first two samples could be m hours apart whereas the time between the next two samples can be more or less than m hours (i.e., m±k hours). It is also possible that an expected interval may be relatively large because of missing or corrupted samples. Thus, k could be even higher than it would be when the sample is not missed.

A third aspect is that the prediction time interval (e.g., m+h) associated with predicted microbial colony image data 116 can be very long compared to the intervals between samples. For example, the prediction time interval 122 between a last sampled image of microbial colony image sequence 112 (e.g., image 112C) and predicted microbial colony image data 116 may be hours to days apart.

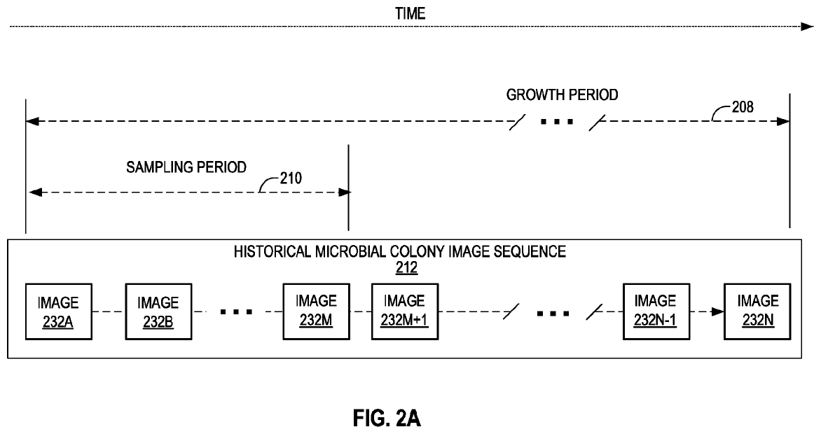

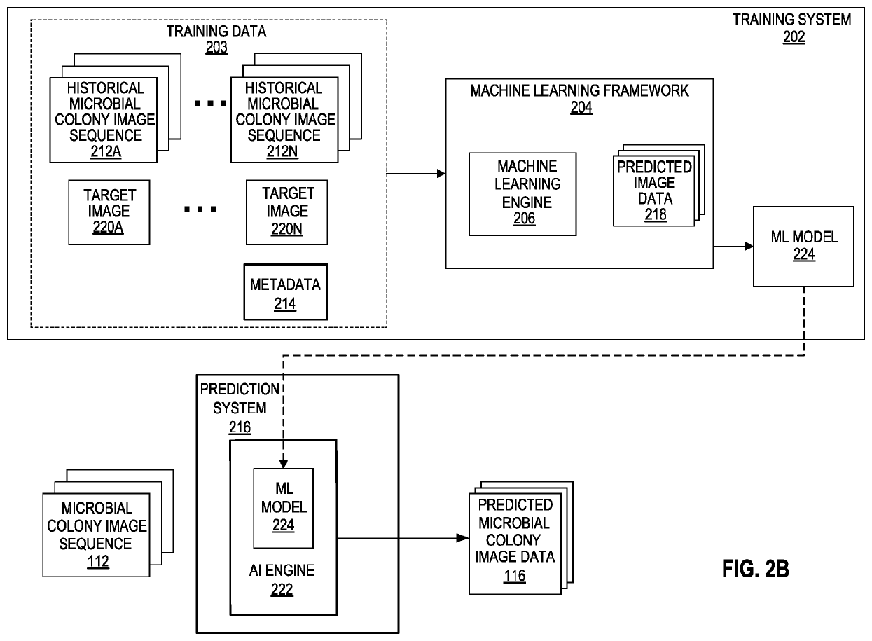

FIG. 2A is a block diagram illustrating training data for a training system such as the training system discussed below with reference to FIG. 2B. In some aspects, the training data includes multiple historical microbial colony image sequences. A historical microbial colony image sequence 212 includes images 232A-232N that comprise image data for a sequence of images of a corresponding historical microbial colony captured at different points in time during growth period 208 of the historical microbial colony. In some aspects, as will be further described below, training data can include images captured during a sampling period 210 (e.g., images 232A-232M). The final image of the sequence, image 232N, can be a target image for the sequence. That is, the final image 232N may be used as the ground truth with respect to the historical microbial image colony's growth. In some aspects, as will also be further described below, the training data may include images captured during sampling period 210 (e.g., images 232A-232M) and images captured after sampling period 210 (e.g., images 232M+1-232N−1).

FIG. 2B is a block diagram illustrating a training system, in accordance with at least one example technique described in this disclosure. Training system 202 can include a machine learning framework 204 that includes machine learning engine 206. Machine learning framework 204 can receive training data 203, and process the training data to generate machine learning model 224. In some aspects, machine learning framework 204 includes machine learning engine 206 that may use supervised or unsupervised machine learning techniques to train machine learning model 224. In some aspects, machine learning engine 206 can be a deep learning engine implementing a convolutional neural network (CNN). In some aspects, machine learning engine 206 can be a generative adversarial network (GAN), for example. As an example, machine learning engine can be a T-Adversarial GAN. In some aspects, machine learning engine 206 can be a U-Net based machine learning engine, including U-Net 2D and U-Net 3D architectures. U-Net architectures can be used to preserve content such as spatial information in the training data. U-Net architectures typically have contracting and expansive paths, and in conjunction with skip connection in the layers, can be used to link corresponding feature maps on the encoder and decoder. The linking of feature maps can facilitate reuse of features in the encoder, thereby reducing information loss. Additionally, U-Net architectures can be computationally efficient and can be trained with a relatively small dataset.

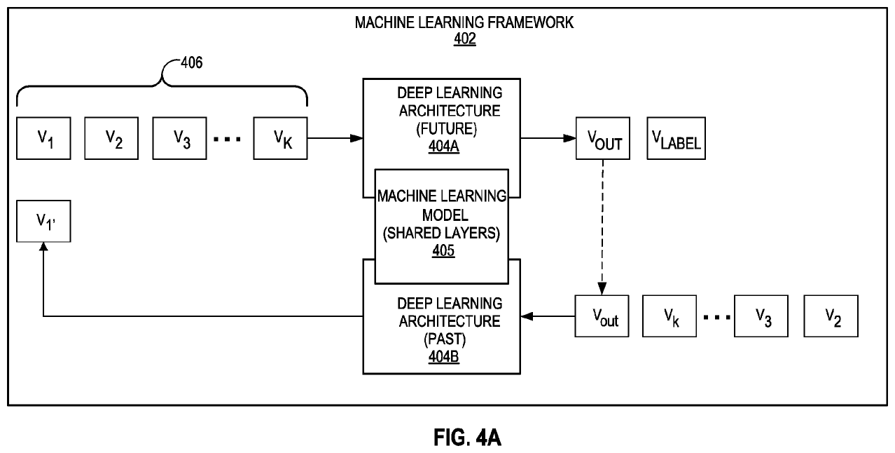

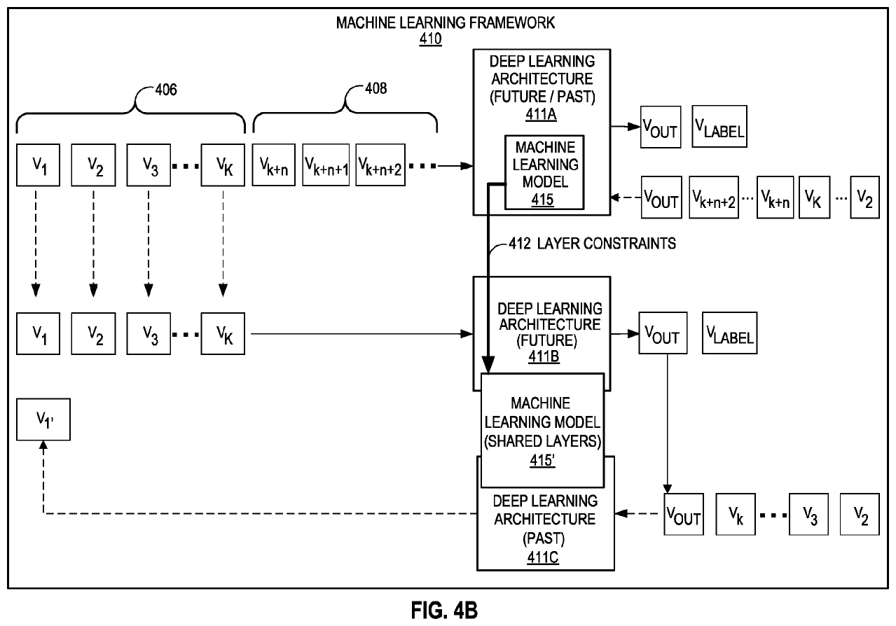

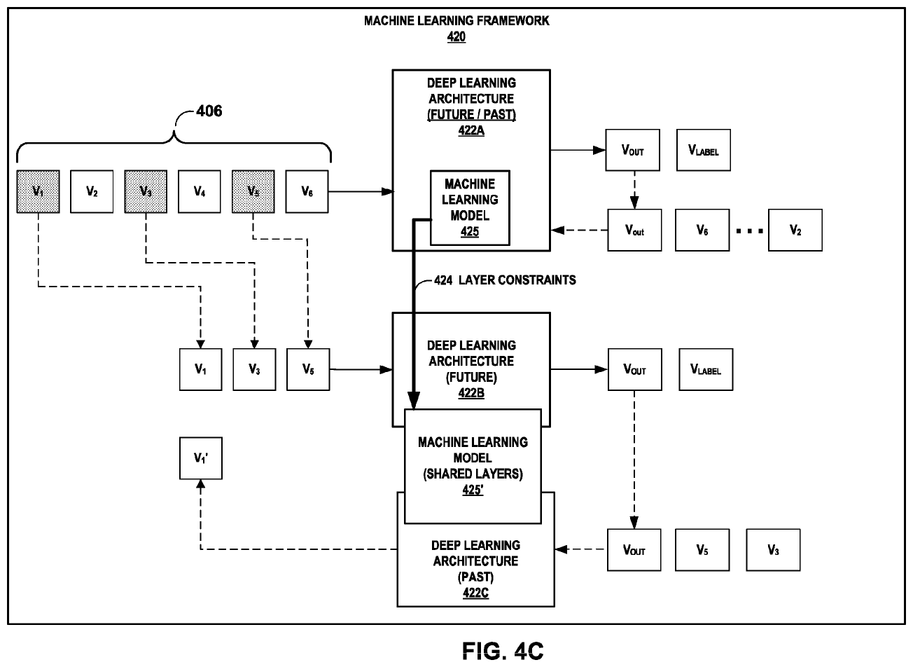

In some aspects, machine learning framework 204 may implement multiple machine learning techniques that can be applied together when training machine learning model 224. For example, machine learning engine 206 may be a U-Net engine and machine learning framework may apply cyclic learning techniques using machine learning engine 206. Further details on machine learning framework and cyclic learning are provided below with respect to FIGS. 4A-4C.

Training data 203 can include historical microbial colony image sequences 212A-212N (generically referred to as a historical microbial colony image sequence 212). Each historical microbial colony image sequence 212 in the training data is a sequence of images of growth of a particular microbial colony captured or recorded over a time period prior to training machine learning model 224.

For example, historical microbial colony image sequence 212A may be image data for a sequence of images showing growth of a first microbial colony over time, historical microbial colony image sequence 212B may be image data for a sequence of images showing growth of a second microbial colony over time, historical microbial colony image sequence 212C may be image data for a sequence of images showing growth of a third microbial colony over time, etc.

Each historical microbial colony image sequence 212A-212N in training data 203 can have a corresponding target image 220A-220N. The target image for an image sequence is the “ground truth” final image e.g., an actual image of the microbial colony associated with the image sequence captured at the end of the growth period.

Training data 203 may also include metadata 214 that can be used for training machine learning model 224. Metadata 214 can include timestamps indicating when images in historical microbial colony image sequence 212 were captured, environmental conditions associated with the sample and sample plates, growth media etc. In some aspects, metadata 214 may be added to training system 202 (or prediction system 102 of FIG. 1) in at least two by padding the metadata information on the boundary of the image. In some aspects, metadata may be added as a vector to a latent feature vector produced in a mid-layer of the machine learning model 224.

Training system 202 provides training data 203 to machine learning framework 204 for processing by machine learning engine 206. Machine learning engine 206 processes historical microbial colony image sequence 212 to generate a predicted image data 218. Predicted image data 218 can include a sequence of predicted future images that each have an associated future time. Machine learning framework 204 can compare a predicted future image to target image 220 associated with historical microbial colony image sequence 212 to determine differences between the predicted future image and target image 220. The difference between predicted future image and target image 220 is used to update training weights in machine learning model 224 to attempt to improve the model's ability to generate accurate predicted future images. In some aspects, the weights in machine learning model 224 can be adjusted using a loss function, such as reconstruction loss or GAN loss.

In some aspects, training system 202 weights images in historical microbial colony image sequence 212 to influence their effect on training machine learning model 224. For example, images in historical microbial colony image sequence 212 that are captured later during the input time interval may be weighted more than images captured earlier in sequence 212. This reflects the fact that images captured later in an input time interval may be closer to the target image 220 associated with the sequence, and therefore have greater training value.

After training system 202 has trained machine learning model 224, the model may be deployed to prediction system 216. Prediction system 216 may be an implementation of prediction system 102 of FIG. 1. Prediction system 216 can receive microbial colony image sequence 112 and process the image sequence using AI engine 222 and the deployed machine learning model 224 to generate predicted microbial colony image data 116.

As shown in FIG. 2B, machine learning framework 204 can generate predicted image data 218 that can include a sequence of images (e.g., 2D images or 3D volumes). In some aspects, machine learning framework 204 can generate predicted image data 218 that can be a single 2D image or 3D volume. Additionally, a historical microbial colony image sequence 212 can be a sequence of multiple images as shown in FIG. 2B. In some aspects, a microbial colony image sequence 212 may be a single image (e.g., a single 2D image or single 3D volume), and machine learning framework 204 may train machine learning model 224 to generate predicted image data 218 from a single input image.

In some aspects, machine learning engine 206 can implement a weighted loss function that assigns different weights to images in predicted image data 218. For example, the weighted loss function may assign a greater weight to an image that is later in the sequence of images that an image that is earlier in the sequence. In other words, a first predicted future image having an associated predicted future time that is earlier the predicted future time associated with a second predicted future image will have a weight that is less than the second predicted future image. This can be desirable because a predicted future image that is accurate and later in time in the sequence of predicted images can be more valuable to an end user than another predicted image that is predicted for a future time that is earlier in the sequence.

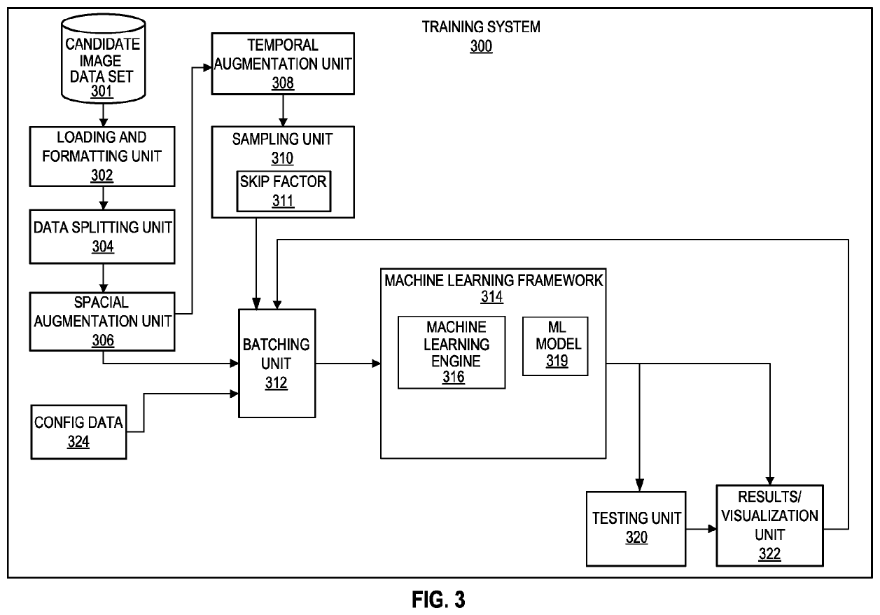

FIG. 3 is a block diagram illustrating further aspects of a training system, in accordance with at least one example technique described in this disclosure. In the example shown in FIG. 3, training system 300 includes loading and formatting unit 302, data splitting unit 304, spatial augmentation unit 306, temporal augmentation unit 308, sampling unit 310, batching unit 312, machine learning framework 314, testing unit 320, and results visualization unit 322. Loading and formatting unit 302, data splitting unit 304, spatial augmentation unit 306, temporal augmentation unit 308, sampling unit 310, batching unit 312, machine learning framework 314, testing unit 320, and results visualization unit 322 can be implemented as a configurable pipeline to process candidate image data set 301 into batches of image data sets to be used by machine learning framework 314 to train machine learning model 319.

Loading and formatting unit 302 can process a candidate image data set 301 to format image sequences in candidate image data set 301 into a form that the training system can process. For example, images may be scaled, resized, cropped etc. so that they are in a format that is compatible with machine learning framework 314.

Data splitting unit 304 can divide candidate image data set 301 into training data, testing data, and/or validation data. For example, input parameters may specify percentages of a data set to use as training data, testing data, and/or validation data.

Spatial augmentation unit 306 can increase the amount of training data by transforming an existing image into one or more additional training images. For example, an image may be transformed by taking a section of the image and moving the section left, right, along a diagonal axis, rotating the image, mirroring the image etc. to create a new image that can be included in the training data.

Temporal augmentation unit 308 can control the selection of images from candidate image data set 301 based on temporal aspects of the candidate training data. Temporal augmentation unit 308 can select image sequences based on where the image is positioned on a time axis. As an example, temporal augmentation unit 308 can select images based on a starting time and an ending time.

Sampling unit 310 can select images from the training data according to a skip factor 311. For example, rather than including every image in candidate image data set 301, sampling unit 310 may select a subset of images in the candidate data set. Skip factor 311 may be used to control the manner in which images are selected. For example, a skip factor of four may cause the sampling unit 310 to skip four images of the candidate data set before selecting a next image for inclusion in training data.

Configuration data 324 can include data that determines data sources, hyperparameters, machine learning parameters, types of machine learning etc. for use by machine learning framework 314.

Batching unit 312 creates and controls batches of training data that are to be processed as a unit. For example, a first batch of training data may be used to train a first machine learning model 319 and a second batch of training data may be used to train a second machine learning model 319. Batching unit 312 may use configuration data 324 to determine which data sources to use for a batch of training data. Batching unit 312 may also use configuration data 324 to specify configuration parameters that machine learning framework 314 is to use when training machine learning model 319 using the corresponding batch of training data.

Batching unit 312 can provide a batch of training data to machine learning framework 314 for use in training machine learning model 319. Machine learning framework 314 can include machine learning engine 316. In some aspects, machine learning framework 314 and/or machine learning engine 316 can be implementations of machine learning framework 204 and/or machine learning engine 206 of FIG. 2B. As discussed above, machine learning engine 316 can be a deep learning engine implementing a CNN, a GAN, a U-Net based machine learning engine, including U-Net 2D and U-Net 3D architectures.

Testing unit 320 can test machine learning model 319 to determine the accuracy of predicted microbial colony images generated using machine learning model 319. Testing unit 320 can receive testing data as input and can generate, using machine learning model 319, a predicted microbial image colony as output. Testing unit 320 can compare the predicted microbial colony image with a target microbial colony image representing the “ground truth”. For example, as described above, a candidate data image set 301 can be split into training data and testing data.

Machine learning framework 314 can train machine learning model 319 using the techniques described herein to generate predicted microbial colony images. Once trained, testing unit 320 can apply the generated machine learning model 319 to historical microbial colony image sequences in the test data to generate predicted microbial colony images. The predicted microbial colony images can be compared to target microbial colony images for the test data to determine the accuracy of machine learning model 319. As an example, the test data may include a historical sequence of images of the growth of a microbial colony, where the last image in the sequence can be the target microbial colony image. Testing unit 320 may apply machine learning model 319 to a first portion of the historical sequence of images to generate a predicted microbial colony image. Testing unit 320 can the compare the predicted microbial colony image with the target microbial colony image and determine, based on the comparison, the accuracy of the predicted microbial colony image. Testing unit 320 can determine various measurements of the performance of machine learning model 319, and compare the measurements with other machine learning models that may have been generated using different training parameters and/or training data. The results of the comparison can be used to determine a machine learning model 319 that produces better (e.g., more accurate) predicted microbial colony images.

Results visualization unit 322 can provide feedback to a user regarding the training of machine learning model 319. For example, results visualization unit 322 can output statistics regarding the accuracy of predicted microbial colony images generated by machine learning model 319. In some aspects, results visualization unit 322 can output examples of input microbial colony image sequences and the predicted microbial colony image generated by machine learning model 319. A user can utilize the output of results visualization unit 322 to determine if any adjustments need to be made with respect to training machine learning model 319. For example, a user may adjust hyperparameters, prediction time intervals, or other configuration data 324 and signal batching unit 312 to begin to provide another batch of training data to train a new machine learning model 319. Results visualization unit 322 can provide output that can be used to compare the performance of machine learning model 319 with other machine learning models. Training system 300 need not include all of the components illustrated in FIG. 3, and in various implementations, training system 300 can include various combinations of one or more of the components illustrated in FIG. 3.

FIGS. 4A-4C are block diagrams illustrating example bi-directional machine learning frameworks used in the training systems illustrated in FIGS. 2 and 3, in accordance with at least one example technique described in this disclosure. For the purposes of describing the examples illustrated in FIGS. 4A-4C, it can be assumed that microbial growth takes twenty-four hours to fully grow and develop. The machine learning model is to be trained to generate a predicted microbial colony image using a sequence of input images 406 captured during the first six hours of growth, thereby potentially cutting eighteen hours off of the waiting time between obtaining a sample and obtaining a result. In the examples illustrated in FIGS. 4A-4C, image sequence 406 is a sequence of k videos V₁-Vₖ, where V₁ is the first video in the sequence and Vₖ is the last video in the six-hour sequence. Vₒᵤₜ is a predicted future image generated by the machine learning framework using image data selected from the first six hours of images 406 and V_{label} is an image that represents a “ground truth” image, also referred to as a target image.

FIG. 4A is a block diagram illustrating a machine learning framework 402 that performs two passes through an image sequence to train a machine learning model to predict a future microbial colony image. Machine learning framework 402 can be an implementation of machine learning framework 204 of FIG. 2B and/or machine learning framework 314 of FIG. 3. Machine learning framework 402 includes two deep learning architectures 404A and 404B. Deep learning architecture 404A is used to train machine learning model 405 to generate a predicted future image from a sequence of past images, and deep learning architecture 404B is used to train machine learning model 405 to reconstruct a past image from later images and the predicted future image. Deep learning architecture 404A and 404B each may be a CNN (include U-Net 2D and U-Net 3D), a GAN, a T-Adversarial GAN, a Time Cyclic GAN, or a GAN using privileged information. In some aspects, deep learning architecture 404A and 404B share the layers in machine learning model 405. The shared layers provide a constraint on the learning where past information is linked with future information such that the predicted future image can be used to reconstruct a past image. In the example illustrated in FIG. 4A, the goal of the first pass is to generate, using deep learning architecture 404A, a predicted future image Vₒᵤₜ that is the same or similar to the ground truth image V_{label}. Vₒᵤₜ is compared with V_{label}, and the difference between Vₒᵤₜ and V_{label} is used to update training weights in deep learning architecture 404A to attempt to improve the generated predicted future image Vₒᵤₜ. In some aspects, the weights in machine learning model 405 can be adjusted using a loss function, such as reconstruction loss or GAN loss. The above-described process is generally the same as that used for single-direction training of some implementations.

In the second pass, a side goal is to use deep learning architecture 404B to generate a reconstructed first image in the sequence, V₁′ that is the same as or similar to the actual first image in the sequence, V₁, using subsequent images V₂-Vₖ and the predicted future image Vₒᵤₜ as input to deep learning architecture 404B. V₁′ is compared to V₁ and the difference is used to adjust weights in the layers of machine learning model 405. This second pass can make the layer weights more robust, and can avoid over-fitting the machine learning model to the training data.

FIG. 4B is a block diagram illustrating a machine learning framework 410 that performs two stages of bi-directional passes to train a machine learning model to predict a future microbial colony image. Machine learning framework 410 includes deep learning architectures 411A, 411B, and 411C (collectively “deep learning architectures 411”). Deep learning architectures 411 each may be a CNN (include U-Net 2D and U-Net 3D), a GAN, a T-Adversarial GAN, a Time Cyclic GAN, or a GAN using privileged information.

In some aspects, deep learning architecture 411A is implemented similarly to deep learning architectures 404A and 404B described above with reference to FIG. 4A. That is, deep learning architecture 411A can be bi-directional and can perform two passes through an image sequence, namely, a first pass the generates a predicted future image Vₒᵤₜ from initial images in an image sequence 406, and a second pass that generates a reconstructed first image V₁ based on the predicted future image Vₒᵤₜ and images subsequent to the first image in the image sequence. In some aspects, deep learning architecture 411A differs from deep learning architectures 404A and 404B of FIG. 4A by including a longer time range of image data in training a machine learning model. For instance, in addition to input images 406 collected during an initial six-hour period of microbial growth (e.g., V₁-Vₖ), deep learning architecture 411A may also include images 408 collected during a later portion of the twenty-four hour growth period. As an example, images from hours nineteen to twenty-three (e.g., images Vₖ₊ₙ, Vₖ₊ₙ₊₁, Vₖ₊ₙ₊₂ etc.) may be provided as training data to deep learning architecture 411A.

In the example illustrated in FIG. 4B, a first stage of generating machine learning model 415 includes using machine learning architecture 411A to train machine learning model 415 to generate a predicted future image Vₒᵤₜ that is the same as or similar to the ground truth image V_{label}. Vₒᵤₜ is compared with V_{label}, and the difference between Vₒᵤₜ and V_{label} is used to update training weights in machine learning model 415 to attempt to improve the generated predicted future image Vₒᵤₜ. In some aspects, the weights in machine learning model 415 can be adjusted using a loss function, such as reconstruction loss or GAN loss. Additionally, deep learning architecture 411A trains machine learning model 415 to reconstruct the first image V₁ from Vₒᵤₜ and images subsequent to V₁. As noted above, in the example illustrated in FIG. 4B, the input to deep learning architecture 411A during the first stage of machine learning includes both images captured in the first six hours of the twenty-four hour period (e.g., V₁-Vₖ), and images captured later in the twenty-four hour period (e.g., images Vₖ₊ₙ, Vₖ₊ₙ₊₁, Vₖ₊ₙ₊₂ etc. captured during the hours nineteen to twenty-three). Thus, in the first stage of training, machine learning framework 410 takes advantage of a longer time frame of data to improve the accuracy of machine learning model 415.

While it can be advantageous to use a longer time frame to improve the accuracy of a predicted future image, an aspect of the techniques disclosed herein is a machine learning model that can generate a predicted future image using images captured during earlier stages of growth without relying on later images. Thus, in the example illustrated in FIG. 4B, during a second stage, machine learning framework 410 continues to train machine learning model 415′ using images 406 captured during the first six hours of growth. As was the case with the first stage, the second stage of training can be bi-directional with deep learning architecture 411B sharing layers of machine learning model 415′ with deep learning architecture 411C. For example, deep learning architecture 411B trains machine learning model 415′ to generate a predicted future image Vₒᵤₜ using input images 406 (e.g., V₁-Vₖ) and compares Vₒᵤₜ to V_{label} to determine adjustments to the weights of machine learning model 415′. Additionally, deep learning architecture 411C trains machine learning model 415′ to generate a reconstructed image V₁′ using Vₒᵤₜ and Vₖ-V₂ as input and compares V₁′ to V₁ to determine adjustments to the weights of machine learning model 415′.

Machine learning framework 410 can impose constraints 412 on the training of machine learning model 415′. For example, machine learning framework 410 can enforce a constraint that certain layers of machine learning model 415′ match the weights of corresponding layers of machine learning model 415. In some aspects, the constraint can be that the weights of the final layer of machine learning model 415′ match the weights of the final layer of machine learning model 415. In some aspects, the constraint can be that the weights of a middle layer of machine learning model 415′ match the weights of a corresponding middle layer of machine learning model 415.

In addition to the aspects discussed above, a further aspect of the disclosure illustrated in FIG. 4B is that additional data obtained in the future can be used to train machine learning model 415′. For example, machine learning model 415 may be trained using an initial set of training data. As further data becomes available at a future point in time, machine learning model 415′ may be trained as discussed above to potentially improve the accuracy of the predicted images.

In the example illustrated in FIG. 4B, machine learning framework 410 implements bi-directional training (i.e., cyclic training) to train both machine learning model 415 and machine learning model 414′. However, bi-directional training is not a requirement, and in some aspects, machine learning framework 410 can train either or both machine learning models 415 and 415′ using a single direction.

FIG. 4C is a block diagram illustrating another machine learning framework 420 that performs two stages of bi-directional passes to train a machine learning model to predict a future microbial colony image. Machine learning framework 420 includes deep learning architectures 422A, 422B, and 422C (collectively “deep learning architectures 422”). Deep learning architectures 422 each may be a CNN (include U-Net 2D and U-Net 3D), a GAN, a T-Adversarial GAN, a Time Cyclic GAN, or a GAN using privileged information.

In some aspects, deep learning architecture 425A is implemented similarly to deep learning architectures 404A and 404B described above in FIG. 4A and deep learning architecture 411A described above in FIG. 4B. That is, deep learning architecture 422A can be bi-directional and can perform two passes through an image sequence, e.g., a first pass that generates a predicted future image Vₒᵤₜ from initial images in an image sequence 406, and a second pass that generates a reconstructed first image V₁ based on the predicted future image Vₒᵤₜ and images subsequent to the first image in the image sequence. Deep learning architecture 422A, like deep learning architecture 411A, includes more training data than the example shown in FIG. 4A. However, in the example of FIG. 4C, the additional training data obtained may include a greater number of sampled images from images 406 obtained during the initial six hour period of the twenty-four hour period. In the example illustrated in FIG. 4C, deep learning architecture 422A initially trains machine learning model 425 using images V₁-V₆. Thus, in the first stage of training, deep learning architecture 422A takes advantage of more image samples to improve the accuracy of machine learning model 425.

During the second stage, deep learning architecture 422B trains machine learning model 425′ using fewer images from images 406. In the example illustrated in FIG. 4C, deep learning architectures 422B and 422C use half the number of images (e.g., V1, V3 and V5). As was the case with the first stage, the second stage of training can be bi-directional with deep learning architecture 422B sharing layers of machine learning model 425′ with deep learning architecture 422C. For example, deep learning architecture 422B trains machine learning model 425′ to generate a predicted future image Vₒᵤₜ using input images 406 (e.g., V₁, V₃ and V₅) and compares Vₒᵤₜ to V_{label} to determine adjustments to the weights of machine learning model 425′. Additionally, deep learning architecture 422C trains machine learning model 425′ to generate a reconstructed image V₁′ using Vₒᵤₜ, V₅ and V₃ as input and compares V₁′ to V₁ to determine adjustments to the weights of machine learning model 425′.

Machine learning framework 420 can impose constraints 424 on the training of machine learning model 425′. For example, machine learning framework 420 can enforce a constraint that certain layers of machine learning model 425′ match the weights of corresponding layers of machine learning model 425. In some aspects, the constraint can be that the weights of the final layer of machine learning model 425′ match the weights of the final layer of machine learning model 425. In some aspects, the constraint can be that the weights of a middle layer of machine learning model 425′ match the weights of a corresponding middle layer of machine learning model 425.

In addition to the aspects discussed above, a further aspect of the disclosure illustrated in FIG. 4C is that despite utilizing fewer samples during an initial phase (e.g., a test phase) of training, the machine learning framework 420 can still produce a machine learning model 425′ that may have the same or similar accuracy as a machine learning model that is trained using more samples.

Like the example illustrated in FIG. 4B, the example illustrated in FIG. 4C, machine learning framework 420 implements bi-directional training (i.e., cyclic training) to train both machine learning model 425 and machine learning model 425′. However, bi-directional training is not a requirement, and in some aspects, machine learning framework 410 can train either or both machine learning models 415 and 415′ using a single direction.

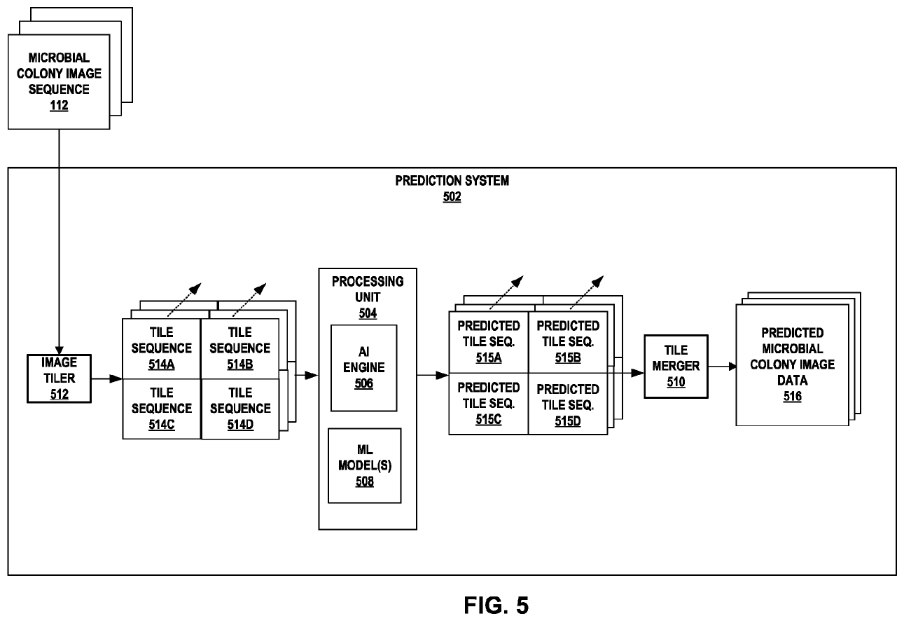

FIG. 5 is a block diagram showing a system for generating a predicted future image of microorganism (e.g., bacteria, mold, fungi) colony growth using tiled image data, in accordance with at least one example technique described in this disclosure. In some aspects, images of the microbial growth image sequence may be tiled prior to training a machine learning model. Tiling may be used in addition to other image transformations to generate more image data for use in training a machine learning model. For example, image tiles may be randomly selected from images in a candidate image data set 301 (FIG. 3) and provided to a training system. Further, tiling may be used to reduce the image size. For example, in some implementations, candidate image data set 301 included images having a size of 1844×1956 pixels. Image tiles were created having an image size of 512×512 pixels. In some aspects, prediction system 502 may not tile the input images if the size of the input image is small and/or if the amount of training data available is already large.

In the example illustrated in FIG. 5, prediction system 502 is configured to tile images as part of generating predicted microbial colony image data 516. Prediction system 502 can be an implementation of prediction system 102 of FIG. 2B and/or prediction system 216 of FIG. 2B. Prediction system 502 includes image tiler 512, processing unit 504, and tile merger 510. Prediction system 502 receives the microbial colony image sequence 112. Image tiler 512 tiles the images in sequence 112 to generate tile sequences 514A-514D. In some aspects, image tiler 512 generates spatially sequential tile sequences. In the example illustrated in FIG. 5, tile sequences 514A-514D are generated left to right and top to bottom. Prediction system 502 provides tile sequences 514A-514D to processing unit 504. Processing unit 504 includes AI engine 506 and machine learning model 508. AI engine processes each of the tile sequences 514A-514D using machine learning model 508 to generate corresponding predicted tiles 515A-515D. Predicted tiles 515A-515D are in the same sequence as the input tile sequences 514A-514D. That is, predicted tile 515A corresponds to tile sequence 514A, predicted tile 515B corresponds to tile sequence 514B, and so on. Tile merger 510 reassembles predicted tiles 515A-515D in the same sequential order to create predict microbial colony image 516.

The example illustrated in FIG. 5 shows image tiler 512 generating four tile sequences for an input image sequence. The number of tile sequences can vary, and may be greater than or less than four.

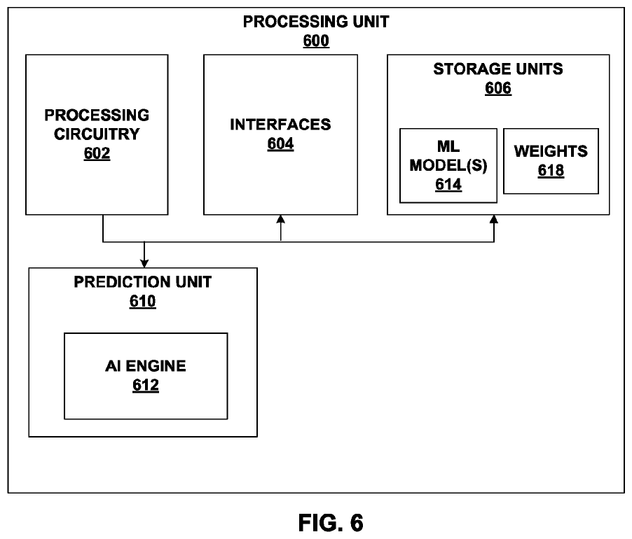

FIG. 6 is a block diagram of an example processing unit of a system for generating a predicted future image of microbial growth, in accordance with at least one example technique described in this disclosure. FIG. 6 is a block diagram illustrating an example processing unit 600, in accordance with at least one example technique described in this disclosure. Processing unit 600 may be an example or alternative implementation of processing unit 104 of FIG. 1 and/or processing unit 504 of FIG. 5. The architecture of processing unit 600 illustrated in FIG. 6 is shown for example purposes only. Processing unit 600 should not be limited to the illustrated example architecture. In other examples, processing unit 600 may be configured in a variety of ways. In the example illustrated in FIG. 6, processing unit 600 includes a prediction unit 610 configured to generate a predicted microbial colony image based on a sequence of microbial colony images. prediction unit 610 can include AI engine 612 configured to process the microbial colony image sequences using machine learning model 614 to generate a predicted microbial colony image as output.

In some aspects, machine learning model 614 can data defining a CNN. In some aspects, machine learning model 614 can include data defining a generative adversarial network (GAN), a T-Adversarial GAN, a U-Net, including U-Net 2D and U-Net 3D.

Processing unit 600 may be implemented as any suitable computing system, (e.g., at least one server computer, workstation, mainframe, appliance, cloud computing system, and/or other computing system) that may be capable of performing operations and/or functions described in accordance with at least one aspect of the present disclosure. In some examples, processing unit 600 represents a cloud computing system, server farm, and/or server cluster (or portion thereof) configured to connect with system 100 via a wired or wireless connection. In other examples, processing unit 600 may represent or be implemented through at least one virtualized compute instance (e.g., virtual machines or containers) of a data center, cloud computing system, server farm, and/or server cluster. In some examples, processing unit 600 includes at least one computing device, each computing device having a memory and at least one processor.

As shown in the example of FIG. 6, processing unit 600 includes processing circuitry 602, at least one interface 604, and at least one storage unit 606. Prediction unit 610, including AI engine 612, may be implemented as program instructions and/or data stored in storage units 606 and executable by processing circuitry 602. Storage unit 606 may store machine learning models 614. Storage unit 606 of processing unit 600 may also store an operating system (not shown) executable by processing circuitry 602 to control the operation of components of processing unit 600. The components, units, or modules of processing unit 600 can be coupled (physically, communicatively, and/or operatively) using communication channels for inter-component communications. In some examples, the communication channels include a system bus, a network connection, an inter-process communication data structure, or any other method for communicating data.

Processing circuitry 602, in one example, may include at least one processor that is configured to implement functionality and/or process instructions for execution within processing unit 600. For example, processing circuitry 602 may be capable of processing instructions stored by storage units 606. Processing circuitry 602, may include, for example, microprocessors, digital signal processors (DSPs), application specific integrated circuits (ASICs), field-programmable gate array (FPGAs), or equivalent discrete or integrated logic circuitry, or a combination of any of the foregoing devices or circuitry.

There may be multiple instances of processing circuitry 602 within processing unit 600 to facilitate processing inspection operations in parallel. The multiple instances may be of the same type, e.g., a multiprocessor system or a multicore processor. The multiple instances may be of different types, e.g., a multicore processor with associated multiple graphics processor units (GPUs).

Processing unit 600 may utilize interfaces 604 to communicate with external systems via at least one network. In some examples, interfaces 604 include an electrical interface configured to electrically couple processing unit 600 to prediction system 102. In other examples, interfaces 604 may be network interfaces (e.g., Ethernet interfaces, optical transceivers, radio frequency (RF) transceivers, Wi-Fi, or via use of wireless technology under the trade “BLUETOOTH”, telephony interfaces, or any other type of devices that can send and receive information. In some examples, processing unit 600 utilizes interfaces 604 to wirelessly communicate with external systems.

Storage units 606 may be configured to store information within processing unit 600 during operation. Storage units 606 may include a computer-readable storage medium or computer-readable storage device. In some examples, storage units 606 include at least a short-term memory or a long-term memory. Storage units 606 may include, for example, random access memories (RAM), dynamic random access memories (DRAM), static random access memories (SRAM), magnetic discs, optical discs, flash memories, magnetic discs, optical discs, flash memories, or forms of electrically programmable memories (EPROM) or electrically erasable and programmable memories (EEPROM). In some examples, storage units 606 are used to store program instructions for execution by processing circuitry 602. Storage units 606 may be used by software or applications running on processing unit 600 to temporarily store information during program execution.

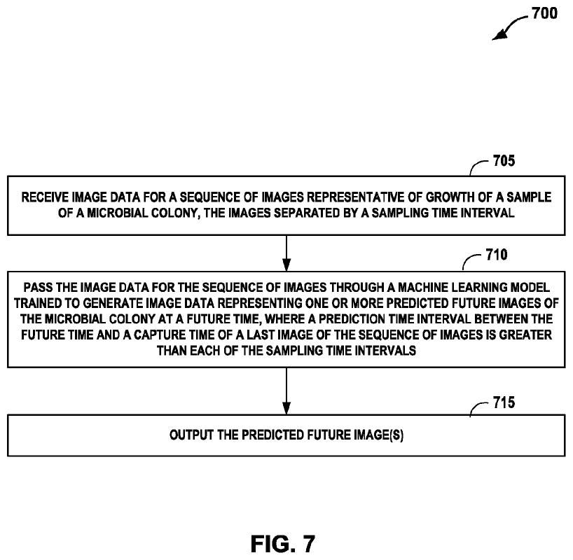

FIG. 7 is a flow diagram illustrating an example operation of a prediction system, in accordance with one or more techniques of this disclosure. The prediction system may receive, by a processing unit comprising one or more processors, image data for a sequence of images representative of a sample of a microbial colony, the images captured at a plurality of times, each image of the images prior to a final image of the sequence of images separated by a sampling time interval between the image and a next image (705). Next, the prediction system may pass the image data for the sequence of images through a machine learning model trained to generate image data representing a predicted future image of the microbial colony at a future time, the machine learning model trained using historical image data, the historical image data comprising a plurality of historical image data sets, each historical image data set of the historical image data sets comprising image data for a historical sequence of images of a corresponding historical microbial colony sample, wherein a prediction time interval between the future time and a capture time of a last image of the sequence of images is greater than each of the sampling time intervals (710). Next, the prediction system may output the image data representing the predicted future image of the microbial colony (715).

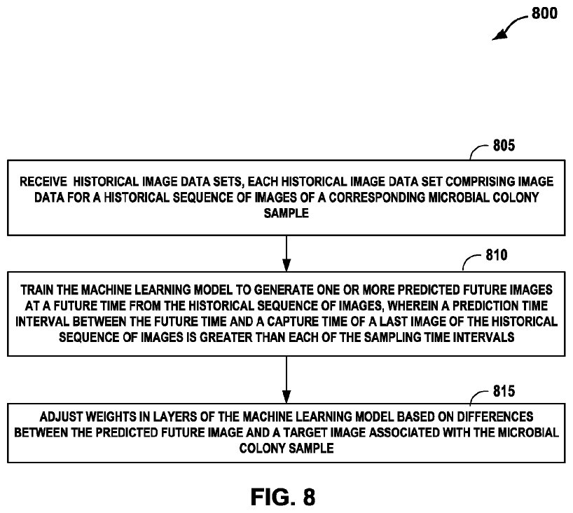

FIG. 8 is a flow diagram illustrating an example operation of a training system, in accordance with one or more techniques of this disclosure. The training system may receive historical image data, the historical image data comprising a plurality of historical image data sets, each historical image data set of the historical image data sets comprising image data for a historical sequence of images of a corresponding microbial colony sample, each image of the historical sequence of images prior to a final image of the historical sequence of images separated by a sampling time interval between the image and a next image (805). Next, the training system may train the machine learning model to generate a predicted future image at a future time from the historical sequence of images, wherein a prediction time interval between the future time and a capture time of a last image of the historical sequence of images is greater than each of the sampling time intervals (810). Next, the training system may adjust weights in layers of the machine learning model based on differences between the predicted future image and a target image associated with the microbial colony sample (815).

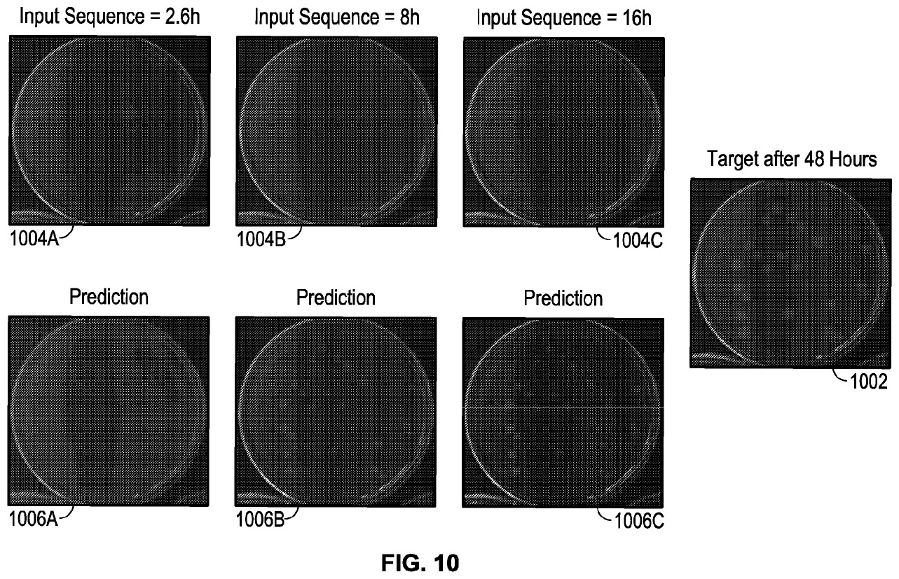

FIG. 10 shows predicted future images generated in accordance with at least one example technique described in this disclosure. FIG. 10 shows the final image of three different input sequences 1004A, 1004B, and 1004C comprising image samples of the same microbial image colony. Predicted future images 1006A, 1006B and 1006C correspond, respectively, to input sequences 1004A, 1004B and 1004C and are the resulting predicted future images generated by a prediction system using the same machine learning model. Each of image sequences 1004A, 1004B and 1004C includes sixteen input images, but are spaced to a different total time. For example, sequence 1004A includes sixteen images sampled during a first 2.6 hours of growth of the microbial colony, resulting in approximately ten minute sampling time intervals between images (e.g., 16 samples×10 minutes per sample=160=2.6 hours) and a 61.4 hour prediction interval. Sequence 1004B includes sixteen images sampled during a first eight hours of growth of the microbial colony, resulting in thirty minute sampling time intervals between images (e.g., 16 samples×30 minutes per sample=480 minutes=8 hours) and a fifty-six hour prediction interval (e.g., 64 hours−8 hours=56 hours). Image sequence 1004C includes sixteen images sampled during a first sixteen hours of growth of the microbial colony resulting in one hour sampling time intervals between images (e.g., 16 samples×1 hour per sample=16 hours) and a forty-eight hour prediction interval (e.g., 64 hours-16 hours=48 hours). Image 1002 is a ground truth image of the growth of the microbial colony after sixty-four hours have elapsed.

As can be seen in FIG. 10, predicted future image 1006A corresponding to image sequence 1004A is not close in appearance to target image 1002. This may indicate that a 2.6 hour image sampling period may not be sufficiently long to generate an accurate predicted future image for microbial colonies having a sixty-four hour growth period. However, predicted future image 1006B corresponding to image sequence 1004B is relatively close to target image 1002, and even though after eight hours, the growth shown in the final image of image sequence 1004B is not yet visible to the human eye. Similarly, predicted future image 1006C corresponding to image sequence 1004C is also relatively close to target image 1002. Thus, the results shown in FIG. 10 indicate that a relatively accurate predicted future image of growth of microbial growth can be obtained using images captured during a first eight or sixteen hours of growth, resulting in a time savings of forty-eight hours (i.e., 64 hours−16 hours) to fifty-six hours (i.e., 64 hours-8 hours) when compared to waiting for the full sixty-four hours of growth.

The examples shown in FIG. 10 utilize an image sequence containing sixteen images. In other implementations, an image sequence may have fewer images or may have a greater number of images. In some implementations, a satisfactory predicted future image may be generated using an input sequence having as few as two to three images.

The discussion above has been presented in the context of predicting future images of a microbial colonies based on images taken earlier in a growth cycle. The techniques discussed herein can be readily applied to other areas as well. For example, the techniques may be applied to wound analytics to generate, based on a sequence of images of the wound, a predicted future image of a wound showing how the wound would appear at a future time.

The techniques of the disclosure may also be applied to farming. Plant growth behavior, like microbial colony growth and wound healing, can have slow and long progressions. Using the techniques described herein, new cultivars and field regions that would be most resistant to diseases can be predicted using image sequences of fields.

The techniques described in this disclosure may be implemented, at least in part, in hardware, software, firmware or any combination thereof. For example, various aspects of the described techniques may be implemented within at least one processor, including at least one microprocessor, DSP, ASIC, FPGA, and/or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit including hardware may also perform at least one of the techniques of this disclosure.

Such hardware, software, and firmware may be implemented within the same device or within separate devices to support the various operations and functions described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware or software components. Rather, functionality associated with at least one module and/or unit may be performed by separate hardware or software components or integrated within common or separate hardware or software components.

The techniques described in this disclosure may also be embodied or encoded in a computer-readable medium, such as a non-transitory computer-readable medium or computer-readable storage medium, containing instructions. Instructions embedded or encoded in a computer-readable medium may cause a programmable processor, or other processor, to perform the method (e.g., when the instructions are executed). Computer readable storage media may include RAM, read only memory (ROM), programmable read only memory (PROM), EPROM, EEPROM, flash memory, a hard disk, a CD-ROM, a floppy disk, a cassette, magnetic media, optical media, or other computer-readable storage media. The term “computer-readable storage media” refers to physical storage media, and not signals or carrier waves, although the term “computer-readable media” may include transient media such as signals, in addition to physical storage media.

What is claimed is:

1. A system comprising:
an image capture device configured to capture image data for a sequence of images representative of growth of a microbial colony at a plurality of times, each of the images prior to a final image of the sequence of images separated by a sampling time interval between the image and a next image; and
a processing unit having one or more processors, the one or more processors configured to execute instructions that cause the processing unit to:
pass the image data for the sequence of images through a machine learning model trained to generate image data representing one or more predicted future images of the growth of the microbial colony, each of the one or more predicted future images representative of the microbial colony at a corresponding future time, the machine learning model trained using historical image data, the historical image data comprising one or more historical image data sets, each historical image data set of the one or more historical image data sets comprising image data for a historical sequence of images of a corresponding historical microbial colony sample, wherein a prediction time interval between the future time and a capture time of a last image of the sequence of images is greater than each of the sampling time intervals, and
output the image data representing the one or more predicted future images of the microbial colony.

2. The system of claim 1, wherein the machine learning model is trained using a weighted loss that assigns a first weight to a first output image that is less than a second weight assigned to a second output image having a corresponding predicted future time that is later than the predicted future time corresponding to the first output image.

3. The system of claim 1, wherein the machine learning model is trained using a weighted loss that assigns equal weighting to each output image.

4. The system of claim 1, wherein the machine learning model is trained bi-directionally, wherein a first direction of training trains the machine learning model to generate the one or more predicted future images from the historical sequence of images and wherein a second direction of training trains the machine learning model to generate a reconstructed first image from the one or more predicted future images and images in the historical sequence of images subsequent to the first image.

5. The system of claim 4, wherein layers in the machine learning model are shared by the first direction of training and the second direction of training.

6. The system of claim 4, wherein:
the machine learning model comprises a second machine learning model;
a first machine learning model is trained prior to the second machine learning model using a first training image data set that includes a first subset of images of the historical sequence of images captured during a sampling period associated with the historical microbial colony sample and a second subset of images captured between an end of the sampling period and an end of a growth period of the historical microbial colony sample; and
the second machine learning model is constrained to include one or more layers of the first machine learning model.

7. The system of claim 6, wherein the first machine learning model is trained bi-directionally.

8. The system of claim 6, wherein the one or more layers comprise a final layer, a penultimate layer, or one or more mid-level layers.

9. The system of claim 1, wherein:
the machine learning model comprises a second machine learning model;
a first machine learning model is trained prior to the second machine learning model using a first training image data set that includes a first subset of images of the historical sequence of images captured during a sampling period associated with the historical microbial colony sample and a second subset of images captured during the sampling period, wherein a number of images in the first subset of images is greater than the number of images in the second subset of images; and
the second machine learning model is constrained to use one or more layers of the first machine learning model.

10. The system of claim 1, wherein:
the instructions further cause the processing unit to generate, from each image in the sequence of images, a corresponding plurality of image tiles associated with the image, each of the image tiles corresponding to a different position in the image;
the instructions to cause the processing unit to pass the image data of the sequence of images through the machine learning model comprise instructions to cause the processing unit to, for each of the different positions, pass the plurality of image tiles corresponding to a same position through the machine learning model to generate a predicted future image tile corresponding to the same position; and
the instructions to cause the processing unit to output the image data representing the predicted future image of the microbial colony comprise instructions to cause the processing unit to assemble the predicted future image tiles for each of the different positions into image data representing the predicted future image of the microbial colony.

11. The system of claim 1, wherein each image in the sequence of images comprises a plurality of frames of a video recording.

12. The system of claim 1, wherein the prediction time interval is greater than an input time interval associated with the sequence of images.

13. The system of claim 1, wherein the microbial colony comprises a bacterial colony, a yeast colony, a fungus colony, or a mold colony.

14. A method comprising:
receiving, by a processing unit comprising one or more processors, image data for a sequence of images representative of growth of a sample of a microbial colony, the images captured at a plurality of times, each image of the images prior to a final image of the sequence of images separated by a sampling time interval between the image and a next image;
passing the image data for the sequence of images through a machine learning model trained to generate image data representing a one or more predicted future images of the microbial colony, each of the one or more predicted future images representative of the microbial colony at a corresponding future time, the machine learning model trained using historical image data, the historical image data comprising a plurality of historical image data sets, each historical image data set of the historical image data sets comprising image data for a historical sequence of images of a corresponding historical microbial colony sample, wherein a prediction time interval between the future time and a capture time of a last image of the sequence of images is greater than each of the sampling time intervals; and
outputting the image data representing the predicted future image of the microbial colony.

15. A method comprising:
receiving historical image data, the historical image data comprising a plurality of historical image data sets, each historical image data set of the historical image data sets comprising image data for a historical sequence of images of a corresponding microbial colony sample, each image of the historical sequence of images prior to a final image of the historical sequence of images separated by a sampling time interval between the image and a next image;
for each historical image data set of the plurality of historical image data sets, training the machine learning model to generate one or more predicted future images of the microbial colony, each image corresponding to a future time from the historical sequence of images, wherein a prediction time interval between the future time and a capture time of a last image of the historical sequence of images is greater than each of the sampling time intervals; and
adjusting weights in layers of the machine learning model based on differences between the one or more predicted future images and one or more target images associated with the microbial colony samples.
